(19) United States
(12) Patent Application Publication
(10) Pub. No.: US 2025/0326234 A1
(43) Pub. Date: Oct. 23, 2025

(54) INKJET PRINTING APPARATUS, CONTROL METHOD, AND STORAGE MEDIUM

(71) Applicant: CANON KABUSHIKI KAISHA, Tokyo (JP)

(72) Inventors: YOSHIAKI MURAYAMA, Tokyo (JP); SATOSHI AZUMA, Tokyo (JP)

(21) Appl. No.: 19/175,517

(22) Filed: Apr. 10, 2025

(30) Foreign Application Priority Data
Apr. 17, 2024 (JP) 2024-066483

(51) Int. Cl. B41J 2/21; B41J 2/14; B41J 2/165; B41J 11/00

(52) U.S. Cl. CPC B41J 2/2142; B41J 2/14153; B41J 2/16517; B41J 2/2103; B41J 2/2135; B41J 2/2146; B41J 11/0095

(57) ABSTRACT

An object of the present disclosure is to prevent unnecessary replacement of a print head. An embodiment of the present invention is a printing apparatus includes: a print head including nozzle arrays disposed at different positions in a first direction and each including multiple nozzles that eject an ink and are arrayed in a second direction crossing the first direction; a recovery unit; a second print area ejection failure determination unit configured to determine, for each of nozzles among the multiple nozzles, whether the nozzle is experiencing ejection failure, the nozzle being present within a second print area larger in width than a first print medium to be subjected to an image printing process; and a notification unit configured to notify of abnormality of the head after the second print area ejection failure determination unit executes a second print area ejection failure determination process.

### BACKGROUND

### Field

The present disclosure relates to an inkjet printing apparatus, a control method, and a storage medium.

### Description of the Related Art

Inkjet printing apparatuses form images by directly ejecting inks onto print media from fine nozzles. For this reason, ejection failure may occur in a case where the inks and/or dust such as paper dust is attached to the nozzle surfaces of the print heads in which nozzles are provided. The occurrence of the ejection failure will result in formation of voids in the form of streaks on printed products (hereinafter, referred to also as “output products”). As a consequence, image defects visually recognizable to the user will appear.

To avoid such image defects, a technique has been proposed which compensates for ejection data which is supposed to be printed by an ejection failure nozzle in a print head with another nozzle capable of ejecting an ink (a technique relating to what is called ejection failure compensation).

Japanese Patent Laid-Open No. 2003-054006 discloses detecting an ejection failure nozzle, compensating for the detected ejection failure nozzle with multiple nozzles in the same scan line, and outputting an abnormality signal in a case where the number of ejection failure nozzles among the nozzles forming the same scan line reaches a predetermined threshold value.

Incidentally, a full-line inkjet printing apparatus as one type of inkjet printing apparatus has been known which includes multiple full-line inkjet heads provided over the entire width of a print medium and arrayed in the direction of movement of the print medium, and ejects inks from the heads to perform one-pass printing.

### SUMMARY

Note that Japanese Patent Laid-Open No. 2003-054006 does not take into account whether the ejection failure nozzle is a nozzle present within a print area determined by the print medium size or a nozzle present outside this print area. For this reason, even in a case where the nozzle is not present in the print area (i.e., present outside the print area), it is counted as an ejection failure nozzle. This leads to a possibility of suggesting unnecessary replacement of the print head.

Thus, in view of the above problem, an object of the present disclosure is to prevent unnecessary replacement of a print head.

An embodiment of the present invention is an inkjet printing apparatus including: a print head including a plurality of nozzle arrays, the plurality of nozzle arrays being disposed at different positions in a first direction, the plurality of nozzle arrays each including a plurality of nozzles that eject an ink and are arrayed in a second direction crossing the first direction; a second print area ejection failure determination unit configured to determine, for each of nozzles among the plurality of nozzles, whether the nozzle is experiencing ejection failure, the nozzle being present within a second print area with a width larger than that of a first print medium to be subjected to an image printing process; and a notification unit configured to notify of abnormality of the print head after the second print area ejection failure determination unit executes a second print area ejection failure determination process in a case where the number of ejection failure nozzles present within a first print area with the width of the first print medium determined by the second print area ejection failure determination unit is more than a predetermined threshold value.

Further features of the present invention will become apparent from the following description of exemplary embodiments with reference to the attached drawings.

### BRIEF DESCRIPTION OF THE DRAWINGS

FIG. 1 is a schematic perspective view illustrating an internal configuration of a printing apparatus;

FIG. 2 is a block diagram illustrating a configuration of the printing apparatus;

FIG. 3 is a block diagram for describing ejection failure processing;

FIG. 4 is a flowchart of an ejection failure compensation process;

FIG. 5 is a diagram for describing a print head;

FIG. 6 is a diagram illustrating a priority table;

FIGS. 7A to 7C are flowcharts of an in-printing ejection failure detection process;

FIG. 8 is a diagram illustrating inspection patterns, and a relationship between ejection failure determination areas and ejection failure count determination areas;

FIG. 9 is a flowchart of a pre-printing print head state determination process;

FIG. 10 is a flowchart of a second ejection failure determination process; and

FIG. 11 is a flowchart of an in-printing ejection failure detection process.

### DESCRIPTION OF THE EMBODIMENTS

### First Embodiment

A case of applying a first embodiment to an inkjet printing apparatus using inkjet full-line heads will now be described below as an application example of the embodiment. Note that the following description will be given taking as an example a high-speed full-line inkjet printing apparatus that uses a continuous sheet wound up in a roll (so-called roll paper).

### Internal Configuration of Printing Apparatus

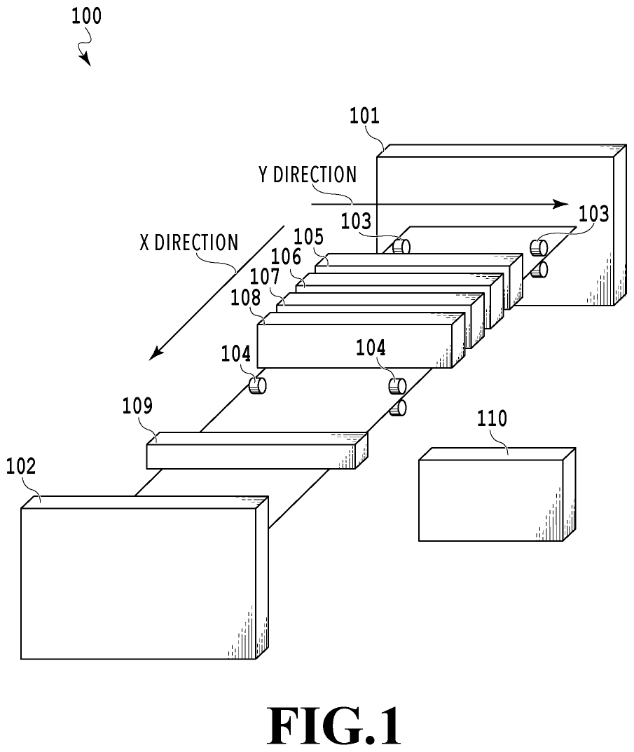

FIG. 1 is a schematic perspective view illustrating an internal configuration of a printing apparatus 100 according to the present embodiment. The printing apparatus 100 includes therein a sheet supply unit 101, a printing unit, and a discharge unit 102.

The sheet supply unit 101 is a unit capable of containing a continuous sheet wound up in a roll as a print medium (to be printed). The sheet supply unit 101 supplies this continuous sheet to the printing unit.

The printing unit is a unit that forms images on the sheet conveyed thereto with first, second, third, and fourth print heads 105, 106, 107, and 108. The printing unit also includes first conveyance rollers 103 and second conveyance rollers 104 that convey the sheet. Incidentally, the first, second, third, and fourth print heads 105, 106, 107, and 108 will be collectively referred to simply as “print heads” herein in a case where no specific distinction is needed.

The print heads are line-type print heads in which inkjet nozzle arrays are formed across a range covering the maximum sheet width that is expected to be used. The first, second, third, and fourth print heads 105, 106, 107, and 108 are arrayed at different positions in the sheet conveyance direction (X direction) in parallel with the Y direction. The first print head 105 corresponds to cyan (C). The second print head 106 corresponds to magenta (M). The third print head 107 corresponds to yellow (Y). The fourth print head 108 corresponds to black (K). Note that the number of print heads and the number of ink colors are not limited to four. For example, a configuration with multiple (two or more) print heads may be employed. Alternatively, a configuration with one long print head formed by multiple chips that have multiple nozzle arrays perpendicular to the sheet conveyance direction and are arrayed in a staggered pattern may be employed.

As for the inkjet method, it is possible to employ a method using heating elements, a method using piezoelectric elements, a method using electrostatic elements, a method using micro-electromechanical systems (MEMS) elements, and the like. A C (cyan) ink is supplied to the first print head 105 through an ink tube from an ink tank (not illustrated). Similarly, M (magenta), Y (yellow), and K (black) inks are supplied to the second, third, and fourth print heads 106, 107, and 108 through corresponding ink tubes from corresponding ink tanks, respectively.

The discharge unit 102 is a unit that conveys sheets cut by a cutter (not illustrated) and, if necessary, sorts the printed sheets by group and discharges them onto different discharge trays (not illustrated). Each of the first, second, third, and fourth print heads 105, 106, 107, and 108 includes a cap for the purpose of preventing drying of the print head while it is not in use, and the print head is capped with this cap while not executing a printing operation. This cap is connected to a pump that generates a negative pressure, and executes a recovery process on the print head by causing the pump to generate the negative pressure in the capping state and thereby sucking in the ink. Also, the first, second, third, and fourth print heads 105, 106, 107, and 108 each have a wiper unit that wipes the nozzle surface.

A reading unit 109 is a unit that reads images of inspection patterns and the like printed by the print heads. The reading unit 109 is, for example, a charge coupled device (CCD) line sensor, and includes two-dimensional image sensors. In the reading unit 109, multiple reading elements are arrayed in a direction crossing the sheet conveyance direction (+X direction), e.g., a direction perpendicularly crossing the sheet conveyance direction (nozzle array direction, Y direction). Also, the reading unit 109 is provided with a light emitting element and the like as well. The width of the reading unit 109 in the nozzle array direction (Y direction) is more than or equal to the width of the print heads. Optically reading the inspection patterns with the reading unit 109 configured as above enables inspection of conditions of the nozzles in the first, second, third, and fourth print heads 105, 106, 107, and 108 and the like.

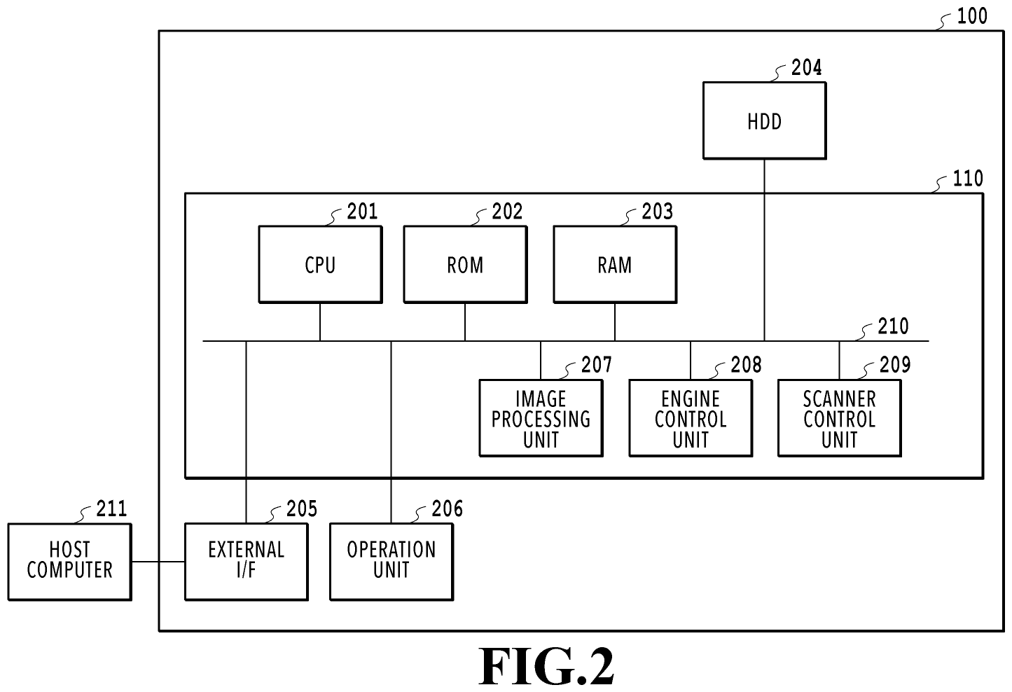

A control unit 110 is a unit that comprehensively controls the printing apparatus 100. The control unit 110 according to the present embodiment will now be described below using FIG. 2. FIG. 2 is a block diagram illustrating a configuration of the printing apparatus according to the present embodiment.

As illustrated in FIG. 2, the control unit 110 has a central processing unit (CPU) 201, a read-only memory (ROM) 202, a random-access memory (RAM) 203, an image processing unit 207, an engine control unit 208, and a scanner control unit 209. Also, a hard disk drive (HDD) 204, an operation unit 206, an external interface (I/F) 205, and so on are connected to the control unit 110 through a system bus 210.

The CPU 201 is a central processing unit in the form of a microprocessor (microcomputer). The CPU 201 controls the operation of the whole printer by executing programs and activating hardware. The ROM 202 stores programs to be executed by the CPU 201 and fixed data necessary for various operations of the printer. The RAM 203 is, for example, used as a work area for the CPU 201 and an area to temporarily store various data received and various setting data. The HDD 204 is incorporated in the printing apparatus 100. Programs to be executed by the CPU 201, print data, and setting information necessary for various operations of the printing apparatus 100 are written in the HDD 204. The CPU 201 is capable of reading out these written programs and so on as needed. Instead of the HDD 204, another large-capacity storage apparatus may be used.

The operation unit 206 includes hardware keys and a touch panel for the user to perform various operations, and a display unit that presents various information to the user (notifies the user of the various information). Note that the method for presenting information to the user is not limited to displaying images on the display unit. For example, information can be presented to the user by outputting a sound (such as a buzzer sound or speech) from a sound generator.

The image processing unit 207 rasterizes (converts) print data to be used in the printing apparatus 100 (e.g., data represented in a page description language) into image data (bitmap image), and performs image processing. For example, the image processing unit 207 converts the color space of image data contained input print data (e.g., YCbCr) into a standard RGB color space (e.g., sRGB). Also, the image processing unit 207 performs various kinds of image processing on the image data such as resolution conversion into an effective number of pixels (a number with which the printing apparatus 100 can perform a printing process), image analysis, and image correction as necessary. The image data obtained by these kinds of image processing is then stored in the RAM 203 or the HDD 204.

The engine control unit 208 is an application-specific integrated circuit (ASIC) that controls a process of printing an image based on print data onto the sheet in accordance with a control command received from the CPU 201 or the like. Specifically, the engine control unit 208 obtains ink ejection instructions for the print heads for the respective colors, an ejection timing setting for adjusting dot positions (ink landing positions) on the print medium, and information on the driving states of the print heads, and performs adjustment and the like based on the obtained information. Also, the engine control unit 208 controls the driving of the print heads based on the print data to eject the inks from the print heads so as to form an image on the sheet. Also, the engine control unit 208 controls a sheet feed roller and the conveyance rollers by, for example, issuing an instruction to drive the sheet feed roller and the conveyance rollers and obtaining information on states of the sheet feed roller and the conveyance rollers regarding their rotations. In this way, the engine control unit 208 is capable of, for example, conveying the sheet at an appropriate speed along an appropriate path and stopping printing as necessary.

The scanner control unit 209 controls the reading unit 109 in accordance with a control command received from the CPU 201 or the like to read images on the sheet. As a result, the scanner control unit 209 obtains red (R), green (G), and blue (B) analog luminance data and converts the obtained analog luminance data into digital data. Also, the scanner control unit 209 issues an instruction to drive the image sensor, and obtains information on the image sensor's state that is based on the driving performed in accordance with the driving instruction. Also, the scanner control unit 209 analyzes the luminance data obtained by the image sensor to, for example, detect whether any of the first, second, third, and fourth print heads 105, 106, 107, and 108 is experiencing ink ejection failure, and detect cut positions on the sheet. A portion of the sheet is subjected to a drying process of drying the inks on the portion in a case where the scanner control unit 209 determines that the image on the portion has been properly printed, and is then discharged onto a designated tray of a sorting unit.

### Ejection Failure Processing

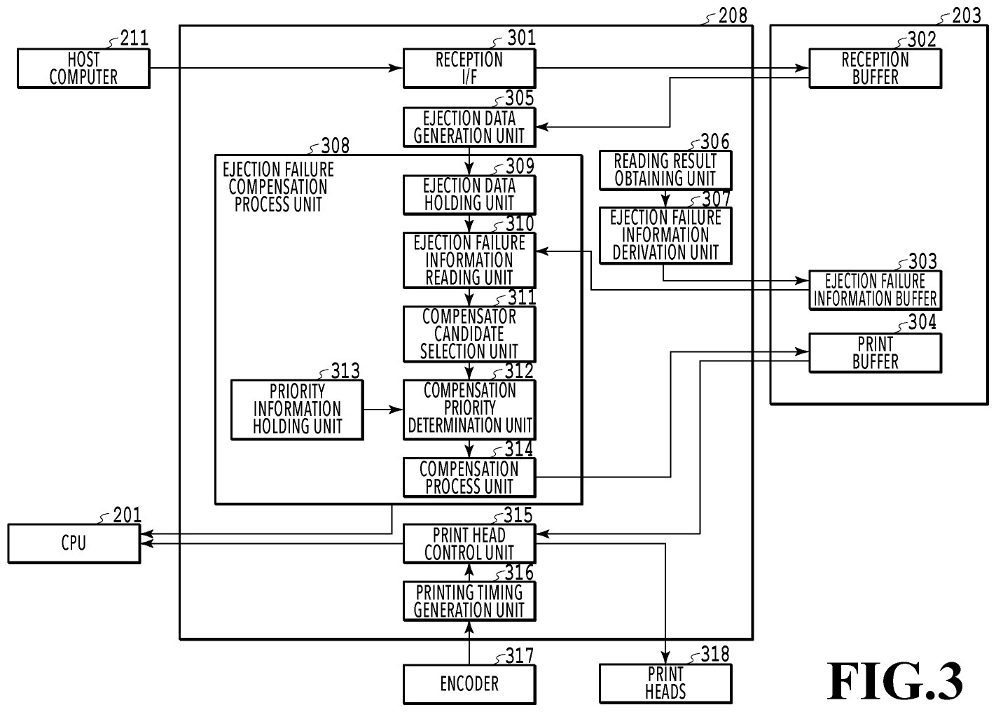

FIG. 3 is a block diagram intended to illustrate a functional configuration of the engine control unit 208. Specifically, FIG. 3 is a diagram for describing processes executed mainly by the engine control unit 208 to detect ejection failure nozzles and compensate for ejection data corresponding to the ejection failure nozzles by using nozzles (this series of processes will be defined as “ejection failure processing”). In the present embodiment, an ejection failure nozzle includes a nozzle experiencing a failure to eject the ink at all, a nozzle experiencing dot misalignment due to ejecting the ink not straightly, and a nozzle experiencing diminished dot printing due to ejecting the ink only in a small amount.

As illustrated in FIG. 3, partial areas in a main memory forming the RAM 203, such as a dynamic random-access memory (DRAM), are provided as a reception buffer 302, an ejection failure information buffer 303, and a print buffer 304. The reception buffer 302 stores image data to be printed sent by a host computer (hereinafter “host PC”) 211 and received via a reception I/F 301 (hereinafter “input image data”). The following description will be given on the assumption that this input image data is quantized image data of each ink color.

An ejection data generation unit 305 reads out the quantized input image data from the reception buffer 302 and generates ejection data for each set of nozzle arrays formed in the print heads based on this input image data. For example, in a case where the print heads each have eight nozzle arrays, the ejection data generation unit 305 generates ejection data for each set of eight nozzle arrays. The ejection data can express whether to eject the ink or not on a nozzle-by-nozzle basis, e.g., “1” representing ejection and “0” representing no ejection. The following description will be given taking a case where the ejection data uses the binary (1 or 0) expression as an example.

A reading result obtaining unit 306 obtains the result of reading of the inspection patterns obtained by the scanner control unit 209 with the reading unit 109, and sends the obtained reading result to an ejection failure information derivation unit 307. The ejection failure information derivation unit 307 analyzes the reading result sent by the reading result obtaining unit 306 and specifies ejection failure nozzles. Identification information on the specified ejection failure nozzles (hereinafter “ejection failure information”) is written to the ejection failure information buffer 303.

An ejection failure compensation process unit 308 includes an ejection data holding unit 309, an ejection failure information reading unit 310, a compensator candidate selection unit 311, a compensation priority determination unit 312, a priority information holding unit 313, and a compensation process unit 314. The ejection failure compensation process unit 308 performs an ejection failure compensation process on the ejection data of each nozzle array and then writes the ejection data after the ejection failure compensation process to the print buffer 304.

A print head control unit 315 reads out the ejection data after the ejection failure compensation process written in the print buffer 304 and sends the read ejection data after the ejection failure compensation process to print heads 318. The print head control unit 315 drives the print heads 318 based on the ejection data after the ejection failure compensation process to thereby print an image on the sheet. At this time, a printing timing generation unit 316 measures the amount of movement of the sheet based on a pulse signal from an encoder 317, and the print head control unit 315 generates print head control signals based on the result of that measurement and sends them to the print heads 318 as driving signals.

### Ejection Failure Compensation Process

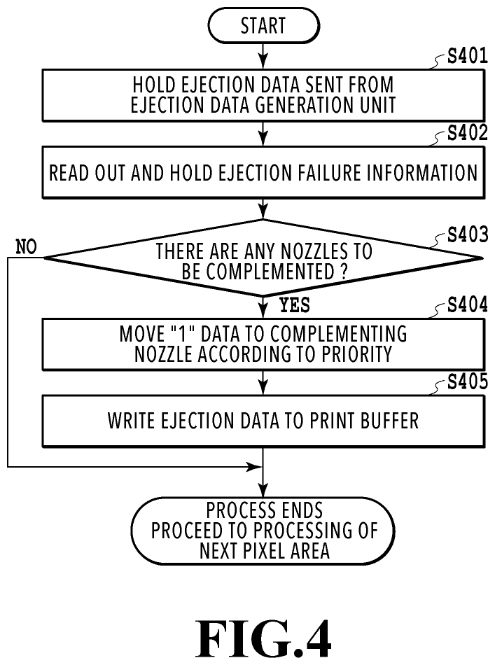

The ejection failure compensation process included in the above-described ejection failure processing will now be described below using FIG. 4. FIG. 4 is a flowchart of a control sequence in the ejection failure compensation process according to the present embodiment. The ejection failure compensation process unit 308 (FIG. 3) performs the ejection failure compensation process by following the control sequence in FIG. 4. Note that the processing of FIG. 4 starts in a case where the amount of ejection data generated by the ejection data generation unit 305 reaches a predetermined threshold value.

In step S401, the ejection data holding unit 309 receives ejection data generated by the ejection data generation unit 305 and holds the received ejection data. In the following, “step S_” will be abbreviated as “S.”

In S402, the ejection failure information reading unit 310 reads out the ejection failure information stored in the ejection failure information buffer 303 and holds the read ejection failure information.

In S403, the ejection failure compensation process unit 308 determines whether there are any compensation target nozzles based on the ejection data held in S401 and the ejection failure information held in S402. That is, the ejection failure compensation process unit 308 determines whether the nozzles assigned “1” in the ejection data include the ejection failure nozzles indicated by the ejection failure information. If the result of the determination in this step is positive, the processing proceeds to S404. On the other hand, if the result of the determination in this step is negative, the ejection failure compensation process is terminated.

In S404, the compensator candidate selection unit 311 moves the ejection data corresponding to a compensation target nozzle (“1” data) to a compensator nozzle according to priority, in other words, converts the “1” data into ejection data corresponding to the compensator nozzle (“1” data). Specifically, based on the ejection data held in S401 and the ejection failure information held in S402, the compensator candidate selection unit 311 firstly selects one or more nozzles satisfying a predetermined condition as candidates that can compensate for the compensation target nozzle. The predetermined condition means that the nozzle is neither an ejection failure nozzle nor assigned “1.” Here, in the case where there are multiple nozzles satisfying the predetermined condition, the compensation priority determination unit 312 reads out priority information held in the priority information holding unit 313, and notifies the compensation process unit 314 of the read priority information. In the case where there is only one candidate that can compensate for the compensation target nozzle, the compensation process unit 314 assigns that one candidate the ejection data assigned to the compensation target nozzle (“1” data). On the other hand, in the case where there are multiple candidates that can compensate for the compensation target nozzle, the compensation process unit 314 determines the one candidate with the highest priority from among the multiple candidates by using the priority information notified of from the priority information holding unit 313. Then, the compensation process unit 314 assigns this determined one candidate the ejection data assigned to the compensation target nozzle (“1” data). Note that the ejection data assigned to the compensation target nozzle (“1” data) will be deleted in response to assigning this ejection data (“1” data) to a nozzle other than the compensation target nozzle. Also, in a case where there is no nozzle satisfying the predetermined condition, the compensator candidate selection unit 311 notifies the CPU 201 that the compensation process cannot be performed due to the absence of a candidate. After the compensation process is finished for all compensation target nozzles, the processing proceeds to S405.

In S405, the compensation process unit 314 writes the ejection data obtained by the process of S404 to the print buffer 304.

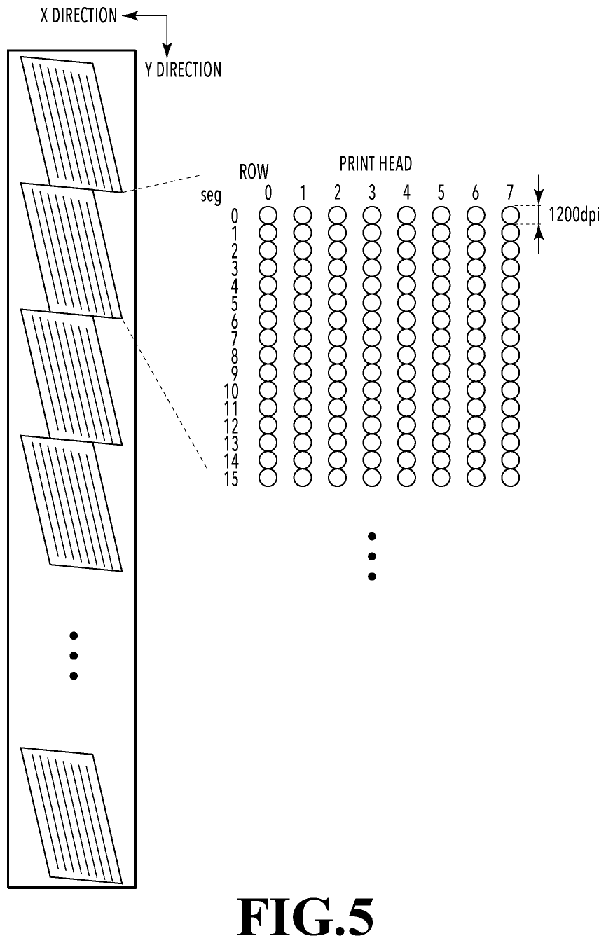

Now, the print heads according to the present embodiment will be described using FIG. 5. The first, second, third, and fourth print heads 105, 106, 107, and 108 have the same configuration. In the present example, as illustrated in FIG. 5, each print head has multiple chips arrayed in the Y direction, and each single chip has eight nozzle arrays. Also, the nozzles forming each nozzle array are arranged at pitches of 1200 dpi in the Y direction. The length of the print head in the Y direction is the width of A2 paper (420 mm). Note that, in the present example, the nozzle arrays in each of the multiple chips are tilted at several degrees from the Y direction. However, the print heads are not limited to this configuration and may be configured such that the nozzle arrays extend in parallel to the Y direction.

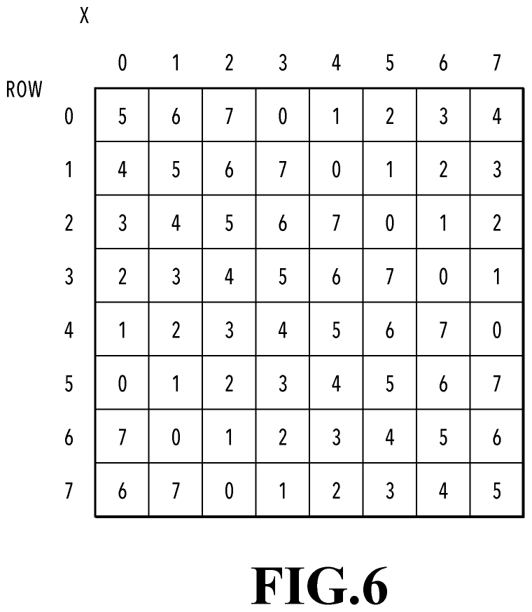

Next, a priority table held in the priority information holding unit 313 will be described using FIG. 6. The numerical values held in the table illustrated in FIG. 6 indicate levels of priority. These levels of priority indicate which one of rows 0 to 7 to preferentially use to compensate for an ejection failure nozzle for each of lines 0 to 7 located at different positions in the X direction. Note that this table repetitively appears in the row direction with the eight lines in the X direction as base units.

### In-Printing Ejection Failure Detection Process

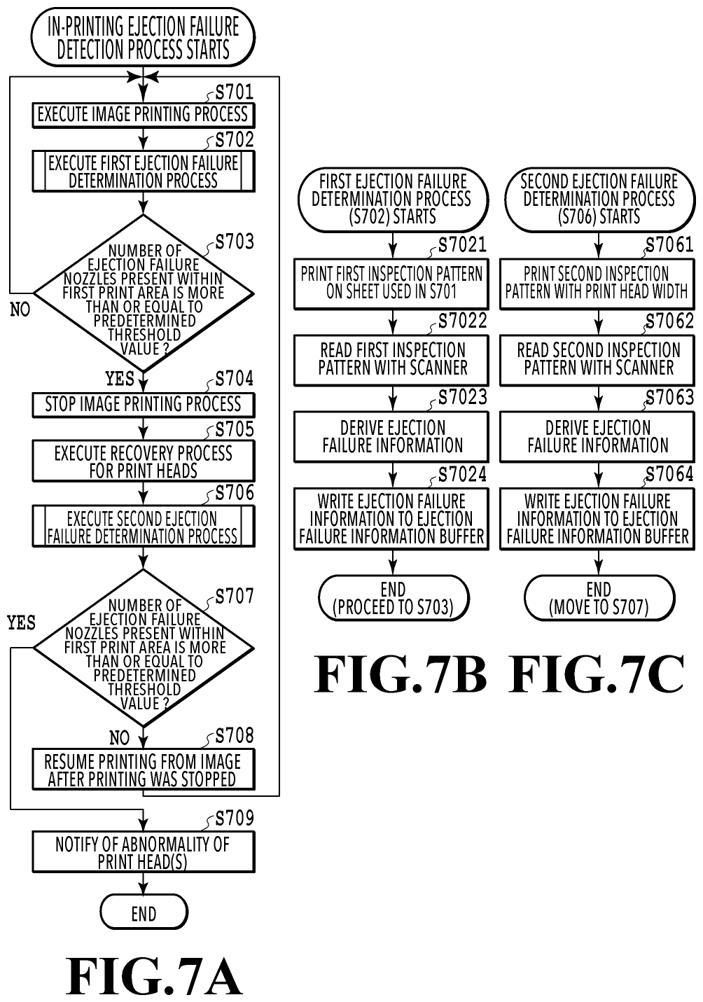

An ejection failure detection process executed during image printing (hereinafter “in-printing ejection failure detection process”) according to the present embodiment will now be described below using FIGS. 7A to 7C. FIG. 7A is a flowchart of the in-printing ejection failure detection process. Note that the following description will be given taking a case of printing images having the width of A4 paper as an example.

In S701, the engine control unit 208 executes an image printing process. Specifically, the engine control unit 208 controls the print head control unit 315 to print images based on the above-mentioned input image data on the sheet. Note that the images to be printed in the present example are multiple page images, and the inspection patterns are printed as a page image representing a single page each time a predetermined number of page images are printed among the multiple page images.

In S702, the engine control unit 208 executes a first ejection failure determination process. Now, the first ejection failure determination process (S702) will be described using FIG. 7B.

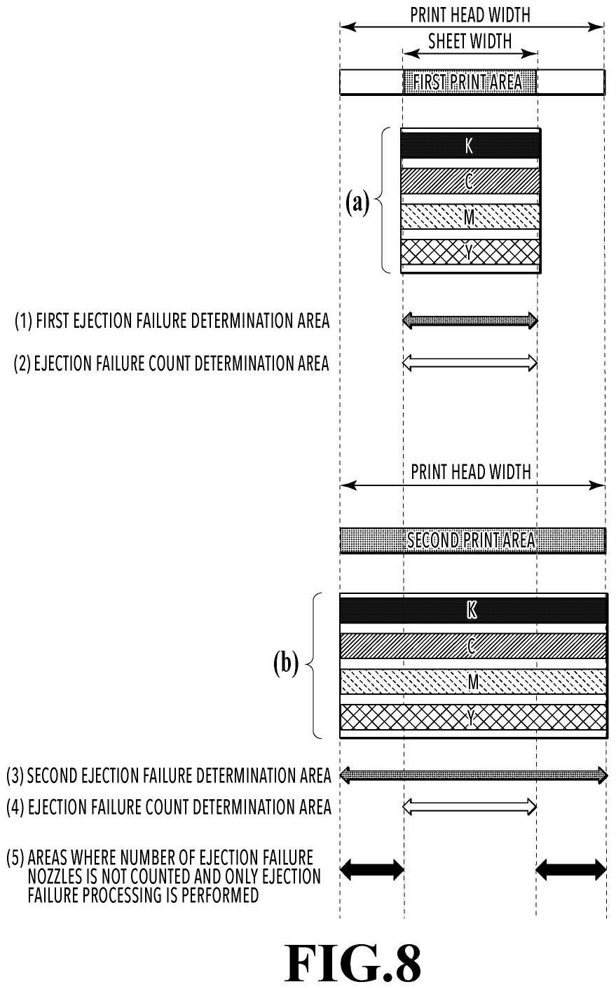

In S7021, the engine control unit 208 controls the print head control unit 315 to print a first inspection pattern on the sheet. At this time, the width of the first inspection pattern to be printed is set to be equal to the length, in the Y direction, of the sheet printed in S701. An area over this length of the sheet in the Y direction will be referred to as “first print area” or “sheet width area” (see FIG. 8). Note that the image data of the inspection patterns is stored in advance in the ROM 202, and the image data of the inspection pattern for the first print area is read out into the reception buffer 302 in the RAM 203 and sent to the ejection data generation unit 305.

In S7022, the engine control unit 208 controls the reading unit 109 to read the first inspection pattern printed in S7021.

In S7023, the ejection failure information derivation unit 307 derives ejection failure information based on the result of the reading in S7022.

In S7024, the ejection failure information derivation unit 307 writes the ejection failure information derived in S7023 to the ejection failure information buffer 303. After this step, the processing proceeds to S703. As described earlier using FIG. 4, writing the ejection failure information to the ejection failure information buffer 303 makes it possible to implement an ejection failure compensation process as a subsequent process. Even in a case where ejection failure occurs during the printing, executing the ejection failure compensation process prevents formation of image defects, such as streaks and unevenness, due to the ejection failure.

The description now returns to FIG. 7A. Incidentally, in a case where an excessively large number of ejection failure nozzles are determined to be experiencing ejection failure in the first ejection failure determination process, image defects may be visually recognized on the output product even if the ejection failure compensation process is executed. To address this, in S703, the engine control unit 208 determines whether or not the number of ejection failure nozzles present within the above-mentioned first print area (see FIG. 8) is more than or equal to a predetermined threshold value based on the ejection failure information written to the ejection failure information buffer 303 in S7024. If the result of the determination in this step is positive, the processing proceeds to S704. If the result of the determination in this step is negative, the processing returns to S701.

In S704, the engine control unit 208 stops the image printing process started in S701.

In S705, the engine control unit 208 executes a recovery process for recovering the ejection performance of the print heads. This recovery process brings the ejection failure nozzles back to such a condition that they can eject the inks. A recovery process that is common in the field of inkjet printing apparatuses may be employed as the recovery process executed in S705. Examples include a suction process of sucking the inks from the nozzles by covering the nozzles with the caps and applying a negative pressure to the caps, and a wiping process of removing paper dust, the inks, and the like attached to the nozzle surfaces by wiping them off with wipers formed of rubber members, nonwoven fabric, or the like. Other possible examples include preliminary ejection in which the inks that have thickened inside the nozzles are ejected into the caps or onto the sheet. Furthermore, two or more of these may be combined. After this step, the processing proceeds to S706.

In S706, the engine control unit 208 executes a second ejection failure determination process. This second ejection failure determination process is executed for the purpose of confirming whether the ejection failure nozzles were recovered by S705.

Now, the second ejection failure determination process (S706) will be described using FIG. 7C. In S7061, the engine control unit 208 controls the print head control unit 315 to print a second inspection pattern on the sheet. Here, the second ejection failure determination process is aimed at deriving ejection failure information on the entireties of the print heads in the Y direction. Thus, the width of the second inspection pattern to be printed in this step is set to be equal to the length of the print heads in the Y direction (print head width). An area over this length of the print heads in the Y direction will be referred to as “second print area” or “print head width area” (see FIG. 8). Note that the image data of the inspection patterns is stored in advance in the ROM 202, and the image data of the inspection pattern for the second print area is read out into the reception buffer 302 in the RAM 203 and sent to the ejection data generation unit 305. Also, the reason for printing the second inspection pattern having the print head width in this step is to avoid image defects due to ejection failure in a case of performing printing on a sheet with a different size from that of the sheet used in an image printing process. Note that while the width of the sheet to be subjected to printing in this step only needs to be more than or equal to the print head width, the second inspection pattern is printed on a sheet with the width of A2 paper in the present example.

In S7062, the engine control unit 208 controls the reading unit 109 to read the second inspection pattern printed in S7061.

In S7063, the ejection failure information derivation unit 307 derives ejection failure information based on the result of the reading in S7062.

In S7064, the ejection failure information derivation unit 307 writes the ejection failure information derived in S7063 to the ejection failure information buffer 303. After this step, the processing proceeds to S707.

In S707, the engine control unit 208 determines whether or not the number of ejection failure nozzles present in the above-mentioned first print area (see FIG. 8) is more than or equal to the predetermined threshold value based on the ejection failure information written to the ejection failure information buffer 303 in S7064. If the result of the determination in this step is positive, it is assumed to be difficult to achieve recovery by the recovery process (S705), and the processing proceeds to S709. On the other hand, if the result of the determination in step S707 is negative, it is assumed that the recovery process (S705) has recovered at least a certain number of ejection failure nozzles, so that the printing apparatus 100 can now avoid image defects, such as streaks and unevenness, due to ejection failure, and the processing proceeds to S708.

In S708, the engine control unit 208 resumes the image printing process stopped in S704. The processing returns to S701 after S708.

In S709, the engine control unit 208 notifies the CPU 201 of abnormality of the print head(s) and, in response to the notification, the CPU 201 notifies the user that the print head(s) have abnormality via the operation unit 206. For example, the CPU 201 may present a message indicating that the print head(s) has (have) abnormality on the display unit of the operation unit 206. Seeing such a message and confirming that the print head(s) has (have) abnormality, the user will request replacement of the print head(s), a check by a serviceman, or the like.

FIG. 8 illustrates a relationship between the inspection patterns printed for the ejection failure determination processes, areas for the ejection failure determination processes (hereinafter “ejection failure determination areas”), and areas for determining the number of ejection failures (hereinafter “ejection failure count determination areas”). Reference sign (a) in FIG. 8, represents the first inspection pattern, and reference sign (b) presents the second inspection pattern. Reference sign (1) in FIG. 8 represents the width of the area where the ejection failure determination process in S702 (first ejection failure determination process) is executed (first ejection failure determination area), which, in the present example, is the length of the first print area in the Y direction, in particular, the width of A4 paper. Reference sign (2) represents the width of the area where the ejection failure count determination process in S703 is executed (ejection failure count determination area), which, in the present example, is the width of A4 paper, as with the width of the area where the first ejection failure determination process is executed.

The width of the area where the ejection failure determination in the second ejection failure determination process (S706) is performed (second ejection failure determination area) is the print head width, as indicated by reference sign (3), and is the width of A2 paper in the present example. On the other hand, the width of the area involved in S707 to determine whether or not the number of ejection failure nozzles is more than or equal to a predetermined threshold value is the width of A4 paper, as indicated by reference sign (4). As indicated by reference sign (5), the areas other than the A4-width area are not subjected to the determination of the number of ejection failure nozzles and are subjected only to the ejection failure processing. This is because, even if ejection failure nozzles are present outside the first print area, which is an area with the width of the sheet currently being printed, they will not affect the image quality of the output product, and therefore counting the number of ejection failure nozzles including those present outside the first print area may result in unnecessary replacement of the print head(s).

### Effect of Present Embodiment

As described above, in the present embodiment, the area where the number of ejection failure nozzles is counted in the determination of the presence of abnormality in the print heads through ejection failure determination during image printing is limited to the first print area, which is an area with the width of the sheet that is being printed in the image printing process. This enables the print heads to avoid being determined to have abnormality as a result of taking into account the ejection failure nozzles present within areas that do not affect the image quality of the output product of the image printing process, and thus prevents unnecessary replacement of the print head(s) from being suggested. This in turn prevents increased user costs and increased downtime due to the unnecessary replacement of the print head(s).

### Second Embodiment

In a second embodiment, an image printing process is preceded by the second ejection failure determination process, and whether the output image to be printed will have a problem is figured out based on information on the image width of the image data to be printed in the image printing process. According to the present embodiment, an image printing process is not executed in a case where the output image to be printed will have a problem. This prevents unnecessary printing. Note that the following description will mainly discuss contents different from the first embodiment, and omit description of contents similar to the first embodiment by, for example, using the same reference signs.

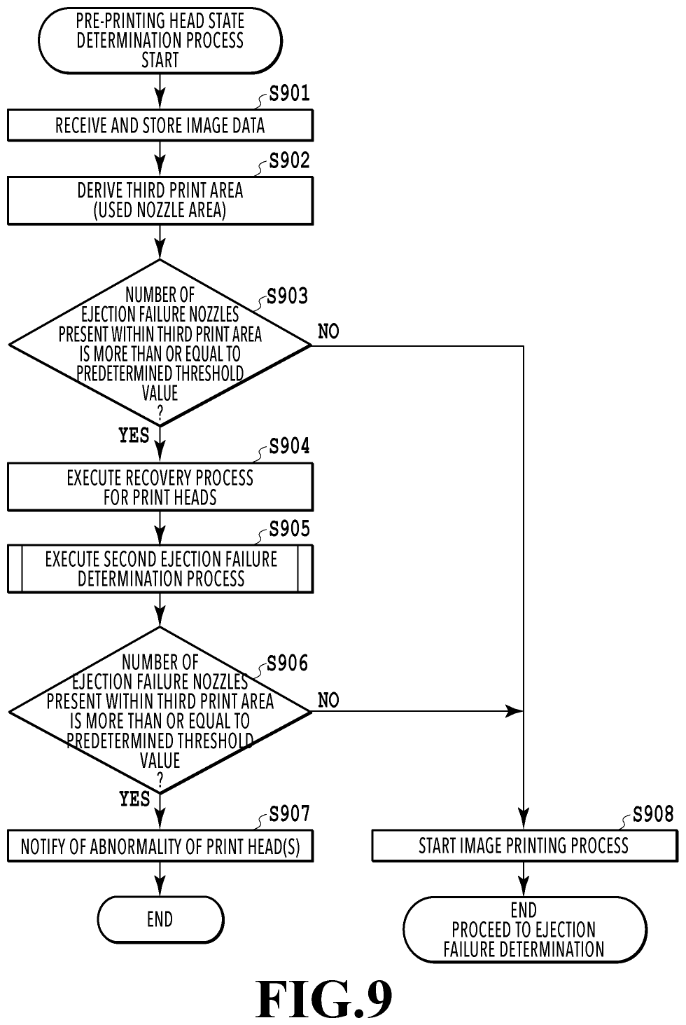

FIG. 9 is a flowchart of a pre-printing print head state determination process according to the present embodiment. The pre-printing print head state determination process is executed before an image printing process is executed. Also, the second ejection failure determination process described earlier (S706 in FIG. 7A) is executed at any timing before the pre-printing print head state determination process.

In S901, the engine control unit 208 of the printing apparatus 100 receives image data sent by the host PC 211 via the reception I/F 301 and stores the received image data in the reception buffer 302.

In S902, based on the image data stored in the reception buffer 302 in S901, the engine control unit 208 derives the area of the nozzles to be used to print the image data. This area will be referred to as “third print area” or “used nozzle area.” The third print area can be derived based on the width of the image represented by the image data.

In S903, the engine control unit 208 determines whether or not the number of ejection failure nozzles present within the third print area among the ejection failure nozzles determined to be experiencing ejection failure in the second ejection failure determination process executed before the process of FIG. 9 is more than or equal to a predetermined threshold value. If the result of the determination in this step is positive, the processing proceeds to S904. On the other hand, if the result of the determination in this step is negative, it is assumed that the printing apparatus 100 can avoid image defects, such as streaks and unevenness, due to ejection failure, and the processing proceeds to S908.

In S904, the engine control unit 208 executes a recovery process for the print heads.

In S905, the engine control unit 208 executes the second ejection failure determination process (see FIG. 7C).

In S906, the engine control unit 208 determines whether or not the number of ejection failure nozzles present within the third print area among the ejection failure nozzles determined to be experiencing ejection failure in the second ejection failure determination process executed in S905 is more than or equal to the predetermined threshold value. If the result of the determination in this step is positive, it is assumed that the recovery process (S904) was executed but could not recover the print heads, and the processing proceeds to S907. On the other hand, if the result of the determination in this step is negative, it is assumed that the printing apparatus 100 can now avoid image defects, such as streaks and unevenness, due to ejection failure, and the processing proceeds to S908.

In S907, the engine control unit 208 notifies the CPU 201 of abnormality of the print head(s) and, in response to the notification, the CPU 201 notifies the user that the print head(s) have abnormality via the operation unit 206. For example, the CPU 201 may present a message indicating that the print head(s) has (have) abnormality on the display unit of the operation unit 206. Seeing such a message and confirming that the print head(s) has (have) abnormality, the user will request replacement of the print head(s), a check by a serviceman, or the like.

In S908, the engine control unit 208 starts the image printing process based on the image data stored in the reception buffer 302 in S901.

### Effect of Present Embodiment, Etc.

As described above, in the present embodiment, whether image detects will appear on an image to be printed is determined based on the result of ejection failure detection executed before the printing of the image with the nozzle area to be actually used (used nozzle area) taken into account. Specifically, whether or not the number of ejection failure nozzles present within the used nozzle area is more than or equal to a predetermined threshold value is determined and, based on the result of this determination, whether any print heads have abnormality is determined. Such a configuration enables the print heads to avoid being determined to have abnormality as a result of taking into account the ejection failure nozzles present in areas that do not affect the image quality of the output product, and thus prevents unnecessary replacement of the print heads from being suggested. This in turn prevents increased user costs and increased downtime due to the unnecessary replacement of the print head(s).

Note that the above-described case involves executing the second ejection failure determination process in S905, but the ejection failure determination process executed in S905 is not limited to the second ejection failure determination process. Instead of the second ejection failure determination process, the first ejection failure determination process described in the first embodiment, in which ejection failure nozzles are determined within the first print area, may be executed.

### Other Embodiments

The first inspection pattern printed in S7021 and the second inspection pattern printed in S7061 have been described as identical patterns with different widths (lengths in the Y direction). Alternatively, the first and second inspection patterns may be different patterns. For example, the first inspection pattern to be printed in the first ejection failure determination process, which is executed during image printing, needs to be read quickly. Hence, a solid pattern to be read at a low resolution may be employed as the first inspection pattern. On the other hand, the second inspection pattern to be printed in the second ejection failure determination process is printed after the image printing is temporarily stopped, and does not need to be read quickly. Hence, a pattern to be read at a high resolution to specifically identify the positions of ejection failure nozzles may be employed as the second inspection pattern.

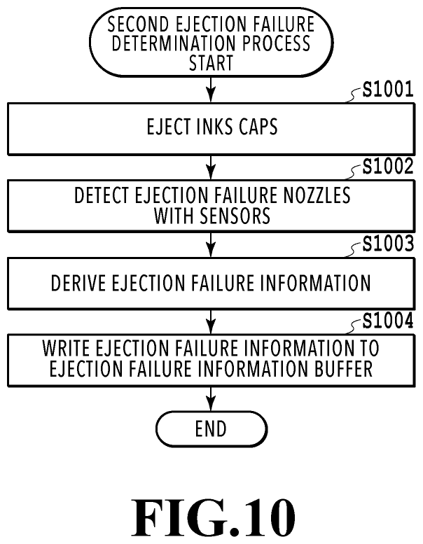

Also, a configuration has been described in which the ejection failure detection in each of the first and second ejection failure determination processes involves printing an inspection pattern on a print medium, reading the printed inspection pattern with the reading unit 109, and deriving ejection failure information based on the result of the reading. However, the present disclosure is not limited to this configuration. The process illustrated in FIG. 10 is an example of another form of the first or second ejection failure determination process.

As illustrated in FIG. 10, firstly in S1001, the CPU 201 ejects the inks into the caps. In S1002, the CPU 201 detects each nozzle's ejection state with a sensor to detect ejection failure nozzles. As a unit used in this step, it is possible to employ a unit disclosed in Japanese Patent Laid-Open No. Hei 8-309963 that ejects an ink between a light emitting element and a light receiving element, and detects whether light emitted from the light emitting element is blocked by ink droplets to detect the occurrence of ejection failure. Also, it is possible employ, as a first ejection failure determination unit or a second ejection failure determination unit, an electrothermal conversion element that generates an ejection energy for ejecting an ink from a nozzle and a temperature detection element that detects the temperature of this electrothermal conversion element which are disclosed in Japanese Patent Laid-Open No. 2023-002736. In this case, each nozzle's ejection state (whether the nozzle is experiencing ejection failure) is determined based on the change in the temperature of the electrothermal conversion element detected by the temperature detection element when the ink is ejected from the nozzle, to detect an ejection failure nozzle. In S1003, the ejection failure information derivation unit 307 derives ejection failure information based on the result of the detection in S1002. This step is similar to S7063 in the first embodiment (FIG. 7C). In S1004, the ejection failure information derivation unit 307 writes the ejection failure information derived in S1003 to the ejection failure information buffer 303. This step is similar to S7064 in the first embodiment (FIG. 7C).

Also, in the above-described embodiments, a configuration has been described which compensates for ejection data (“1” data) for ejection failure nozzles based on ejection failure information. However, the technique of the present disclosure is also applicable to configurations which do not compensate for ejection data for ejection failure nozzles.

Also, in the above-described embodiments, a configuration which performs printing on roll paper has been described. However, the technique of the present disclosure is also applicable to configurations that perform printing on cut sheets.

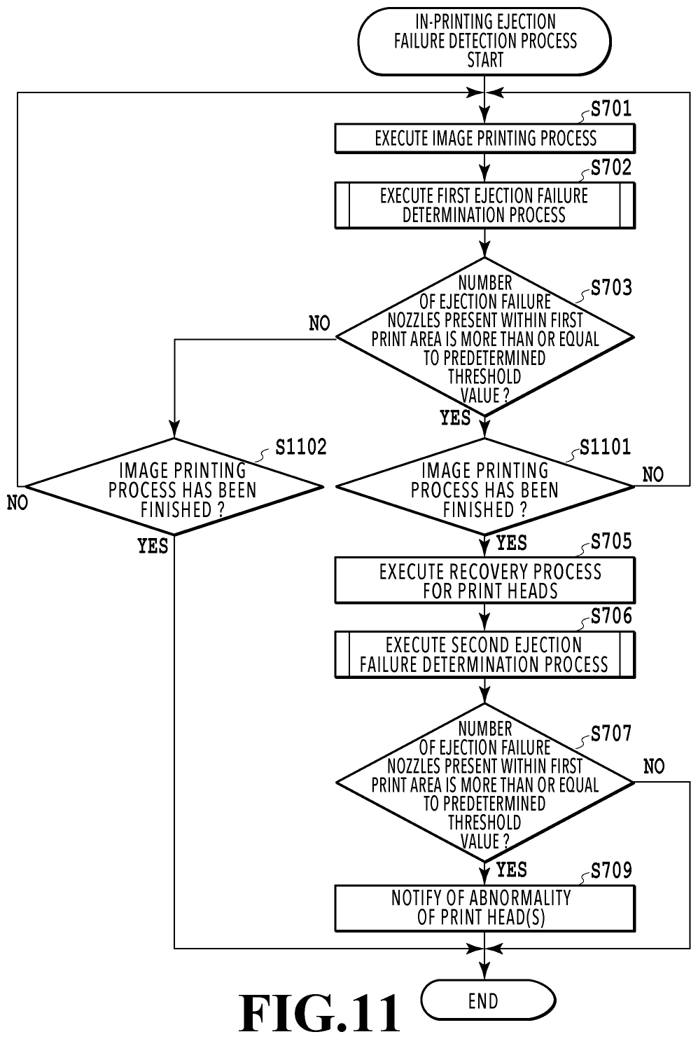

Also, in one of the above-described embodiments, a configuration has been described which stops an image printing process in a case where the number of ejection failure nozzles is more than or equal to a predetermined threshold value while the image printing process is executed (S701→S702→YES in S703→S704 in FIG. 7A). However, the present disclosure is not limited to this configuration. Examples of other forms of the in-printing ejection failure detection process include the form illustrated in FIG. 11. The processes of the steps with step numbers in 700s in FIG. 11 are similar to those in the first embodiment (FIG. 7A). As illustrated in FIG. 11, in S1101 and S1102, the CPU 201 determines whether the image printing process started in S701 has been finished. After the image printing process is finished, the recovery process for the print heads and the subsequent processes may be executed (YES in S703→YES in S1101→S705 . . . ).

Also, the threshold value used in S703 and the threshold value used in S707 may be the same or different. The threshold value used in S903 and the threshold value used in S906 may be the same or different.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present disclosure, it is possible to prevent unnecessary replacement of print heads.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-066483, filed Apr. 17, 2024, which is hereby incorporated by reference wherein in its entirety.

What is claimed is:

1. An inkjet printing apparatus comprising:
a print head including a plurality of nozzle arrays, the plurality of nozzle arrays being disposed at different positions in a first direction, the plurality of nozzle arrays each including a plurality of nozzles that eject an ink and are arrayed in a second direction crossing the first direction;
a second print area ejection failure determination unit configured to determine, for each of nozzles among the plurality of nozzles, whether the nozzle is experiencing ejection failure, the nozzle being present within a second print area with a width larger than that of a first print medium to be subjected to an image printing process; and
a notification unit configured to notify of abnormality of the print head after the second print area ejection failure determination unit executes a second print area ejection failure determination process in a case where the number of ejection failure nozzles present within a first print area with the width of the first print medium determined by the second print area ejection failure determination unit is more than a predetermined threshold value.

2. The inkjet printing apparatus according to claim 1, further comprising
a recovery unit configured to recover ejection performance of the print head by making an ejection failure nozzle among the plurality of nozzles able to eject the ink;
wherein a second print area ejection failure determination unit configured to determine, for each of nozzles among the plurality of nozzles, whether the nozzle is experiencing ejection failure after the recovery unit executes a recovery process.

3. The inkjet printing apparatus according to claim 2, further comprising a first print area ejection failure determination unit configured to determine, for each of nozzles among the plurality of nozzles, whether the nozzle is experiencing ejection failure, the nozzle being present within the first print area with the width of the first print medium, wherein
the second print area ejection failure determination unit executes the second print area ejection failure determination process after the first print area ejection failure determination unit executes a first print area ejection failure determination process and the recovery unit executes the recovery process.

4. The inkjet printing apparatus according to claim 3, further comprising a conveyance unit configured to convey a print medium including the first print medium in the first direction.

5. The inkjet printing apparatus according to claim 3, further comprising:
a first determination unit configured to determine whether or not the number of ejection failure nozzles present within the first print area with the width of the first print medium is more than or equal to the predetermined threshold value after the first print area ejection failure determination unit executes the first print area ejection failure determination process;
a stopping unit configured to stop the image printing process in a case where a result of the determination by the first determination unit is positive;
an execution unit configured to execute the recovery process with the recovery unit after the stopping unit stops the image printing process; and
a second determination unit configured to determine whether or not the number of ejection failure nozzles present within the first print area is more than or equal to the predetermined threshold value after the second print area ejection failure determination unit executes the second print area ejection failure determination process.

6. The inkjet printing apparatus according to claim 5, wherein the notification unit notifies abnormality of the print head in a case where a result of the determination by the second determination unit is positive.

7. The inkjet printing apparatus according to claim 6, further comprising a resumption unit configured to resume the image printing process stopped by the stopping unit in a case where the result of the determination by the second determination unit is negative.

8. The inkjet printing apparatus according to claim 7, further comprising a reading unit configured to read a first inspection pattern printed in the first print area ejection failure determination process or a second inspection pattern printed in the second print area ejection failure determination process, wherein
the first print area ejection failure determination unit and the second print area ejection failure determination unit each derive ejection failure information for identifying an ejection failure nozzle based on a reading result obtained by the reading by the reading unit.

9. The inkjet printing apparatus according to claim 8, wherein the first print area ejection failure determination unit executes the first print area ejection failure determination process while an image printing process is executed on the first print medium.

10. The inkjet printing apparatus according to claim 9, further comprising a third determination unit configured to determine whether the number of ejection failure nozzles present within a third print area derived based on a width of an image to be printed in the image printing process is more than or equal to a predetermined threshold value after the second print area ejection failure determination process preceding the image printing process is executed, wherein
the notification unit notifies abnormality of the print head in a case where a result of the determination by the third determination unit is positive.

11. The inkjet printing apparatus according to claim 10, wherein
the inkjet printing apparatus comprises a plurality of the print heads, and
the plurality of print heads are disposed at different positions in the first direction.

12. The inkjet printing apparatus according to claim 11, wherein the recovery process by the recovery unit is a suction process of sucking the ink from the nozzles by capping the nozzles and applying a negative pressure to the nozzles, a wiping process of wiping a nozzle surface with a wiper, preliminary ejection, or a combination of two or more of the suction process, the wiping process, and the preliminary ejection.

13. The inkjet printing apparatus according to claim 12, wherein
the print head includes an electrothermal conversion element that generates an ejection energy for ejecting the ink from the nozzle, and
the first print area ejection failure determination unit or the second print area ejection failure determination unit includes a temperature detection element that detects a temperature of the electrothermal conversion element.

14. The inkjet printing apparatus according to claim 13, wherein the first print area ejection failure determination unit or the second print area ejection failure determination unit determines an ejection state of each of the nozzles based on a change in the temperature of the electrothermal conversion element detected by the temperature detection element when the ink is ejected from the nozzle.

15. A method of controlling an inkjet printing apparatus including
a print head including a plurality of nozzle arrays, the plurality of nozzle arrays being disposed at different positions in a first direction, the plurality of nozzle arrays each including a plurality of nozzles that eject an ink and are arrayed in a second direction crossing the first direction, and
the method comprising:
determining, for each of nozzles among the plurality of nozzles, whether the nozzle is experiencing ejection failure, the nozzle being present within a second print area with a width larger than that of a first print medium to be subjected to an image printing process; and
notifying of abnormality of the print head after executing the determining in a case where the number of ejection failure nozzles present within a first print area with the width of the first print medium determined in the determining is more than a predetermined threshold value.

16. A non-transitory computer readable storage medium storing a program which causes a computer to execute a method of controlling an inkjet printing apparatus including
a print head including a plurality of nozzle arrays, the plurality of nozzle arrays being disposed at different positions in a first direction, the plurality of nozzle arrays each including a plurality of nozzles that eject an ink and are arrayed in a second direction crossing the first direction, and
the method comprising:
determining, for each of nozzles among the plurality of nozzles, whether the nozzle is experiencing ejection failure, the nozzle being present within a second print area with a width larger than that of a first print medium to be subjected to an image printing process; and
notifying of abnormality of the print head after executing the determining in a case where the number of ejection failure nozzles present within a first print area with the width of the first print medium determined in the determining is more than a predetermined threshold value.
